(19) United States
(12) Patent Application Publication
(10) Pub. No.: US 2015/0062296 A1
(43) Pub. Date: Mar. 5, 2015

(54) DEPTH SIGNALING DATA

(71) Applicant: KONINKLIJKE PHILIPS N.V., EINDHOVEN (NL)

(72) Inventors: Wilhelmus Hendrikus Alfonsus Bruls, Eindhoven (NL); Philip Steven Newton, Eindhoven (NL); Johan Cornelis Talstra, Eindhoven (NL); Wiebe De Haan, Eindhoven (NL)

(21) Appl. No.: 14/391,415

(22) PCT Filed: Apr. 10, 2013
(86) PCT No.: PCT/IB2013/052857

§ 371 Date: Oct. 9, 2014

Related U.S. Application Data
(60) Provisional application No. 61/623,668, filed on Apr. 13, 2012.

(51) Int. Cl. H04N 13/00

(52) U.S. Cl. CPC H04N 13/0059; H04N 13/0022; H04N 2013/0081
USPC 348/43

(57) ABSTRACT

A 3D video system for transmission of 3D data towards various types of 3D displays is described. A 3D source device (40) provides a three dimensional [3D] video signal (41) to a 3D destination device (50). The 3D destination device receives the 3D video signal, and has a destination depth processor (52) for providing a destination depth map for enabling warping of views for the 3D display. The 3D source device generates depth signaling data, which represents depth processing conditions for adapting, to the 3D display, the destination depth map or the warping of views. The 3D video signal contains the depth signaling data. The destination depth processor adapts, to the 3D display, the destination depth map or the warping of views in dependence on the depth signaling data. The depth signaling data enables the rendering process to get better results out of the depth data for the actual 3D display.

### FIELD OF THE INVENTION

The invention relates to a 3D source device for providing a three dimensional [3D] video signal for transferring to a 3D destination device. The 3D video signal comprises first video information representing a left eye view on a 3D display, and second video information representing a right eye view on the 3D display. The 3D destination device comprises a receiver for receiving the 3D video signal, and a destination depth processor for providing a destination depth map for enabling warping of views for the 3D display. The 3D source device comprises an output unit for generating the 3D video signal, and for transferring the 3D video signal to the 3D destination device.

The invention further relates to a method of providing a 3D video signal for transferring to a 3D destination device.

The invention relates to the field of generating and transferring a 3D video signal at a source device, e.g. a broadcaster, internet website server, authoring system, manufacturer of Blu-ray Disc, etc., to a 3D destination device, e.g. a Blu-ray Disc player, 3D TV set, 3D display, mobile computing device, etc., that requires a depth map for rendering multiple views.

### BACKGROUND OF THE INVENTION

The document “Real-time free-viewpoint viewer from multiview video plus depth representation coded by H.264/AVC MVC extension, by Shinya Shimizu, Hideaki Kimata, and Yoshimitsu Ohtani, NTT Cyber Space Laboratories, NTT Corporation, 3DTV-CON, IEEE 2009” describes 3D video technologies in addition to MPEG coded video transfer signals, in particular Multi View Coding (MVC) extensions for inclusion of depth maps in the video format. MVC extensions for inclusion of depth maps video coding allow the construction of bitstreams that represent multiple views with related multiple supplemental views, i.e. depth map views. According to the document depth maps may be added to a 3D video data stream having first video information representing a left eye view on a 3D display and second video information representing a right eye view on the 3D display. A depth map at the decoder side enables generating of further views, additional to the left and right view, e.g. for an auto-stereoscopic display.

### SUMMARY OF THE INVENTION

Video material may be provided with depth maps. Also, there is a lot of existing 3D video material that has no depth map data. For such material the destination device may have a stereo-to-depth convertor for generating a generated depth map based on the first and second video information.

It is an object of the invention to provide a system for providing depth information and transferring the depth information that is more flexible for enhancing 3D video rendering.

For this purpose, according to a first aspect of the invention, the source device as described in the opening paragraph, comprises a source depth processor for providing depth signaling data, the depth signaling data representing a processing condition for adapting, to the 3D display, the destination depth map or the warping of views, and the output unit is arranged for including the depth signaling data in the 3D video signal.

The method comprises generating the 3D video signal, providing depth signaling data, the depth signaling data representing a processing condition for adapting, to the 3D display, the destination depth map or the warping of views, and including the depth signaling data in the 3D video signal.

The 3D video signal comprises depth signaling data, the depth signaling data representing a processing condition for adapting, to the 3D display, the destination depth map or the warping of views.

In the destination device the receiver is arranged for retrieving depth signaling data from the 3D video signal. The destination depth processor is arranged for adapting, to the 3D display, the destination depth map or the warping of views in dependence on the depth signaling data.

The measures have the effect that the destination device is enabled to adapt the destination depth map or the warping of views to the 3D display using the depth signaling data in the 3D video signal. Hence, when and where available, the depth signaling data is applied to enhance the destination depth map or the warping. Effectively the destination device is provided with additional depth signaling data under the control of the source, for example processing parameters or instructions, which data enables the source to control and enhance the warping of views in the 3D display based on the destination depth map. Advantageously the depth signaling data is generated at the source where processing resources are available, and off-line generation is enabled. The processing requirements at the destination side are reduced, and the 3D effect is enhanced because the depth map and warping of the views are optimized for the respective display.

The invention is also based on the following recognition. The inventors have seen that depth map processing or generation at the destination side, and subsequent view warping, usually provides a very agreeable result. However, in view of the capabilities of the 3D display, such as the sharpness of the images at different depths, at some instants or locations the actual video content may be better presented to the viewer by manipulating the depths, e.g. by applying an offset to the destination depth map. The need, amount and/or parameters for such manipulation at a specific 3D display can be foreseen at the source, and adding said depth signaling data as a processing condition enables enhancing the depth map or view warping at the destination side, while the amount of depth signaling data which must be transferred is limited.

Optionally in the 3D source device the source depth processor is arranged for providing depth signaling data including at least one of an offset; a gain; a type of scaling; a type of edges, as the processing condition. The offset, when applied to the destination depth map, effectively moves objects backwards or forwards with respect to the plane of the display. Advantageously signaling the offset enables the source side to move important objects to a position near the 3D display plane. The gain, when applied to the destination depth map, effectively moves objects away or towards the plane of the 3D display. Advantageously, signaling the gain enables the source side to control movement of important objects with respect to the 3D display plane, i.e. the amount of depth in the picture. The type of scaling indicates how the values in the depth map are to be translated into actual values to be used when warping the views, e.g. bi-linear scaling, bicubic scaling, or how to adapt the viewing cone. The type of edges in the depth information indicates the property of the objects in the 3D video, e.g. sharp edges, for example, from depth derived from computer generated content, soft edges, for example, from natural sources, fuzzy edges, for example, from processed video material, etc. Advantageously, the properties of the 3D video may be used when processing the destination depth data for warping the views.

Optionally, the source depth processor is arranged for providing the depth signaling data for a period of time in dependence of a shot in the 3D video signal. Effectively the depth signaling data applies to a period of the 3D video signal that has a same 3D configuration, e.g. a specific camera and zoom configuration. Usually the configuration is substantially stable during a shot of a video program. Shot boundaries may be known or can be easily detected at the source side, and a set of depth signaling data is advantageously assembled for the time period corresponding to the shot.

Optionally, the source depth processor is arranged for providing depth signaling data including region data of a region of interest as the processing condition to enable displaying the region of interest in a preferred depth range of the 3D display. Effectively, the region of interest is constituted by elements or objects in the 3D video material that are assumed to catch the viewer's attention. The region of interest may be known or can be easily detected at the source side, and a set of depth signaling data is advantageously assembled for indicating the location, area, or depth range corresponding to the region of interest, which enable the warping of views to be adapted to display the region of interest near the optimum depth range of the 3D display (e.g. near the display plane).

Optionally, the source depth processor may be further arranged for updating the region data in dependence of a change of the region of interest exceeding a predetermined threshold, such as a substantial change of the depth position of a face. Furthermore the source depth processor may be further arranged for providing, as the region data, region depth data indicative of a depth range of the region of interest. The region depth data enables the destination device to warp the views while moving object in such depth range to a preferred depth range of the 3D display device. The source depth processor may be further arranged for providing, as the region data, region area data indicative of an area of the region of interest area that is aligned to at least one macroblock in the 3D video signal, the macroblock representing a predetermined block of compressed video data. Such region area data will efficiently be encoded and processed.

Optionally, the 3D video signal comprises depth data. The source depth processor may be further arranged for providing the depth signaling data including a depth data type as a processing condition to be applied to the destination depth map for adjusting the warping of views. The depth data type may include at least one of

a focus indicator indicative of depth data generated based on focus data;

a perspective indicator indicative of depth data generated based on perspective data;

a motion indicator indicative of depth data generated based on motion data;

a source indicator indicative of depth data originating from a specific source;

an algorithm indicator indicative of depth data processed by a specific algorithm;

a dilation indicator indicative of an amount of dilation used at borders of objects in the depth data. The respective indicators enable the depth processor at the destination side to accordingly interpret and process the depth data included in the 3D video signal.

Further preferred embodiments of devices and methods according to the invention are given in the appended claims, disclosure of which is incorporated herein by reference.

### BRIEF DESCRIPTION OF THE DRAWINGS

These and other aspects of the invention will be apparent from and elucidated further with reference to the embodiments described by way of example in the following description and with reference to the accompanying drawings, in which

FIG. 1 shows a system for processing 3D video data and displaying the 3D video data,

FIG. 2 shows a 3D decoder using depth signaling data,

FIG. 3 shows a 3D encoder providing depth signaling data,

FIG. 4 shows an auto-stereo display device and warping multiple views,

FIG. 5 shows a dual view stereo display device and warping enhanced views,

FIG. 6 shows depth signaling data in a 3D video signal,

FIG. 7 shows region of interest depth signaling data in a 3D video signal,

FIG. 8 shows depth signaling data for multiple 3D displays, and

FIG. 9 shows scaling for adapting of the view cone.

The figures are purely diagrammatic and not drawn to scale. In the Figures, elements which correspond to elements already described may have the same reference numerals.

### DETAILED DESCRIPTION OF EMBODIMENTS

There are many different ways in which 3D video signal may be formatted and transferred, according to a so-called a 3D video format. Some formats are based on using a 2D channel to also carry stereo information. In the 3D video signal the image is represented by image values in a two-dimensional array of pixels. For example the left and right view can be interlaced or can be placed side by side or top-bottom (above and under each other) in a frame. Also a depth map may be transferred, and possibly further 3D data like occlusion or transparency data. A disparity map, in this text, is also considered to be a type of depth map. The depth map has depth values also in a two-dimensional array corresponding to the image, although the depth map may have a different resolution. The 3D video data may be compressed according to compression methods known as such, e.g. MPEG. Any 3D video system, such as internet or a Blu-ray Disc (BD), may benefit from the proposed enhancements.

The 3D display can be a relatively small unit (e.g. a mobile phone), a large Stereo Display (STD) requiring shutter glasses, any stereoscopic display (STD), an advanced STD taking into account a variable baseline, an active STD that targets the L and R views to the viewers eyes based on head tracking, or an auto-stereoscopic multiview display (ASD), etc.

Traditionally all components needed for driving various types of 3D displays are transmitted, which entails typically the compression and transmission of more than one view (camera signal) and its corresponding depths, for example as discussed in “Call for Proposals on 3D Video Coding Technology”—MPEG document N12036, March 2011, Geneva, Switzerland. Auto-conversion in the decoder (depth automatically derived from stereo) by itself is known, e.g. from “Description of 3D Video Coding Technology Proposal by Disney Research Zurich and Fraunhofer HHI”, MPEG document M22668, November 2011, Geneva, Switzerland. Views need to be warped for said different types of displays, e.g. for ASD's and advanced STD's for variable baseline, based on the depth data in the 3D signal. However the quality of views warped based on the various types of depth data is limited.

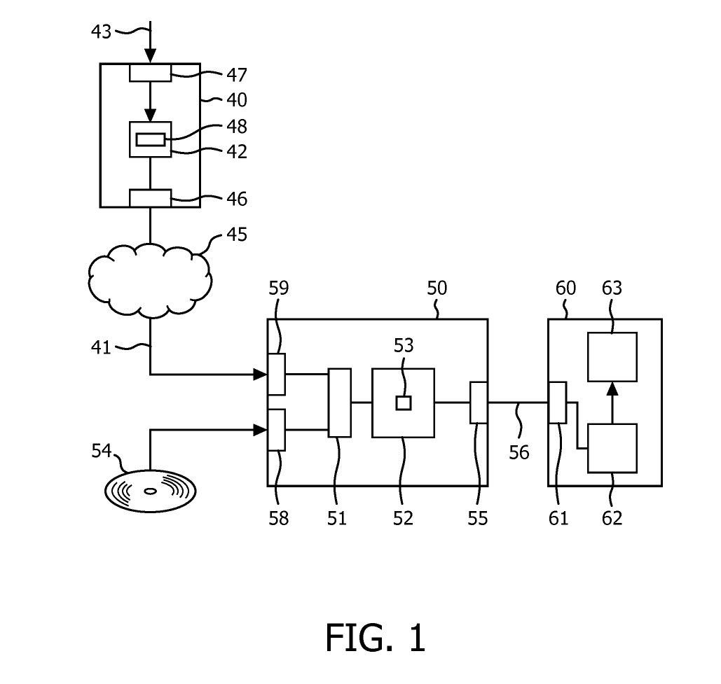

FIG. 1 shows a system for processing 3D video data and displaying the 3D video data. A first 3D video device, called 3D source device 40, provides and transfers a 3D video signal 41 to a further 3D image processing device, called 3D destination device 50, which is coupled to a 3D display device 60 for transferring a 3D display signal 56. The video signal may for example be a 3D TV broadcast signal such as a standard stereo transmission using ½ HD frame compatible, multi view coded (MVC) or frame compatible full resolution (e.g. FCFR as proposed by Dolby Laboratories, Inc.). Building upon a frame-compatible base layer, Dolby developed an enhancement layer to recreate the full resolution 3D images. This technique has been proposed to MPEG for standardization and requires only a ˜10% increase in bitrate. The traditional 3D video signal is enhanced by depth signaling data as elucidated below.

FIG. 1 further shows a record carrier 54 as a carrier of the 3D video signal. The record carrier is disc-shaped and has a track and a central hole. The track, constituted by a pattern of physically detectable marks, is arranged in accordance with a spiral or concentric pattern of turns constituting substantially parallel tracks on one or more information layers. The record carrier may be optically readable, called an optical disc, e.g. a DVD or BD (Blu-ray Disc). The information is embodied on the information layer by the optically detectable marks along the track, e.g. pits and lands. The track structure also comprises position information, e.g. headers and addresses, for indication the location of units of information, usually called information blocks. The record carrier 54 carries information representing digitally encoded 3D image data like video, for example encoded according to the MPEG2 or MPEG4 encoding system, in a predefined recording format like the DVD or BD format.

The 3D source device has a source depth processor 42 for processing 3D video data, received via an input unit 47. The input 3D video data 43 may be available from a storage system, a recording studio, from 3D camera's, etc. The source system may process a depth map provided for the 3D image data, which depth map may be either originally present at the input of the system, or may be automatically generated by a high quality processing system as described below, e.g. from left/right frames in a stereo (L+R) video signal or from 2D video, and possibly further processed or corrected to provide a source depth map that accurately represents depth values corresponding to the accompanying 2D image data or left/right frames.

The source depth processor 42 generates the 3D video signal 41 comprising the 3D video data. The 3D video signal has first video information representing a left eye view on a 3D display, and second video information representing a right eye view on a 3D display. The source device may be arranged for transferring the 3D video signal from the video processor via an output unit 46 and to a further 3D video device, or for providing a 3D video signal for distribution, e.g. via a record carrier. The 3D video signal is based on processing input 3D video data 43, e.g. by encoding and formatting the 3D video data according to a predefined format.

The 3D source device may have a source stereo-to-depth convertor 48 for generating a generated depth map based on the first and second video information. A stereo-to-depth convertor for generating a depth map, in operation, receives a stereo 3D signal, also called left-right video signal, having a time-sequence of left frames L and right frames R representing a left view and a right view to be displayed for respective eyes of a viewer for generating a 3D effect. The unit produces a generated depth map by disparity estimation of the left view and the right view, and may further provide a 2D image based on the left view and/or the right view. The disparity estimation may be based on motion estimation algorithms used to compare the L and R frames, or on perspective features derived from the image data, etc. Large differences between the L and R view of an object are converted into depth values in front of or behind the display screen in dependence of the direction of the difference. The output of the generator unit is the generated depth map.

The generated depth map, and/or the high quality source depth map may be used to determine depth signaling data required at the destination side. The source depth processor 42 is arranged for providing the depth signaling data as discussed now.

The depth signaling data may be generated where depth errors are detected, e.g. when a difference between the source depth map and the generated depth map exceeds a predetermined threshold. For example, a predetermined depth difference may constitute said threshold. The threshold may also be made dependent on further image properties which affect the visibility of depth errors, e.g. local image intensity or contrast, or texture. The threshold may also be determined by detecting a quality level of the generated depth map as follows. The generated depth map is used to warp a view having the orientation corresponding to a given different view. For example, an R′ view is based on the original L image data and the generated depth map. Subsequently a difference is calculated between the R′ view and the original R view, e.g. by the well known PSNR function (Peak Signal-to-Noise Ratio). PSNR is the ratio between the maximum possible power of a signal and the power of corrupting noise that affects the fidelity of its representation. Because many signals have a very wide dynamic range, PSNR is usually expressed in terms of the logarithmic decibel scale. The PSNR may be used now as a measure of quality of generated depth map. The signal in this case is the original data R, and the noise is the error introduced by warping R′ based on the generated depth map. Furthermore, the threshold may also be judged based on further visibility criteria, or by an editor authoring or reviewing the results based on the generated depth map, and controlling which sections and/or periods of the 3D video need to be augmented by depth signaling data

The depth signaling data represents depth processing conditions for adjusting the warping of views at the destination side. The warping may be adjusted to match the 3D video content as carried by the 3D video signal to the actual 3D display, i.e. to optimally use the properties of the 3D display to provide a 3D effect for the viewer in dependence of the actual 3D video content and the capabilities of the 3D video display. For example, the 3D display may have a limited depth range around the display screen where the sharpness of the displayed images is high, whereas images at a depth position in front of the screen, or far beyond the screen, are less sharp.

The depth signaling data may include various parameters, for example one or more of an offset; a gain; a type of scaling; a type of edges, as a processing condition to be applied to the destination depth map for adjusting the warping of views. The offset, when applied to the destination depth map, effectively moves objects backwards or forwards with respect to the plane of the display. Signaling the offset enables the source side to move important objects to a position near the 3D display plane. The gain, when applied to the destination depth map, effectively moves objects away or towards the plane of the 3D display. For example the destination depth map may be defined to have a zero value for a depth at the display plane, and the gain may be applied as a multiplication to the values. Signaling the gain enables the source side to control movement of important objects with respect to the 3D display plane. The gain determines the difference between the closest and the farthest element when displaying the 3D image.

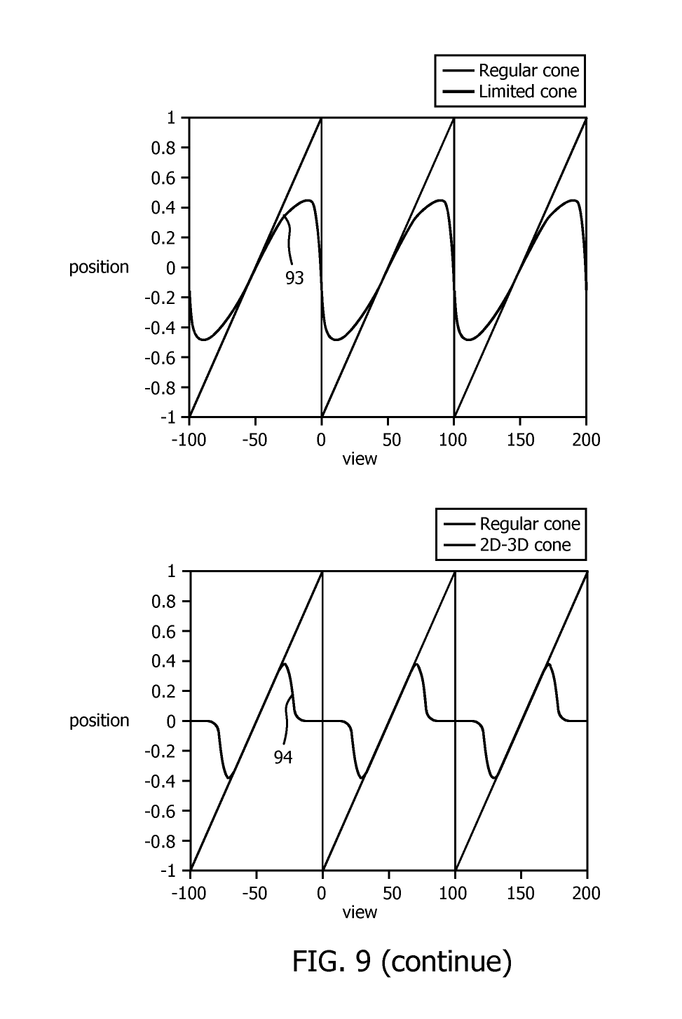

The type of scaling indicates how the values in the depth map are to be translated into actual values to be used when warping the views, e.g. bi-linear scaling, bicubic scaling, or a predetermined type of non-linear scaling. A further type of scaling refers to scaling the shape of the view cone, which is described below with reference to FIG. 9.

The type of edges in the depth information may indicate the property of the objects in the 3D video, e.g. sharp edges, for example, from Computer Generated Content, soft edges, for example, from natural sources, fuzzy edges, for example, from processed video material, etc. The properties of the 3D video may be used when processing the destination depth data for warping the views.

The output unit 46 is arranged for including the depth signaling data in the 3D video signal. A processor unit having the functions of the depth processor 42, the optional stereo-to-depth convertor 48 and the output unit 46 may be called a 3D encoder.

The 3D source may be a server, a broadcaster, a recording device, or an authoring and/or production system for manufacturing optical record carriers like the Blu-ray Disc. The Blu-ray Disc provides an interactive platform for distributing video for content creators. Information on the Blu-ray Disc format is available from the website of the Blu-ray Disc association in papers on the audio-visual application format, e.g. http://www.blu-raydisc.com/Assets/Downloadablefile/2b_bdrom_audiovisualapplication_{—}030 5-12955-15269.pdf. The production process of the optical record carrier further comprises the steps of providing a physical pattern of marks in tracks which pattern embodies the 3D video signal that include the depth signaling data, and subsequently shaping the material of the record carrier according to the pattern to provide the tracks of marks on at least one storage layer.

The 3D destination device 50 has a receiver for receiving the 3D video signal 41, which receiver has one or more signal interface units and an input unit 51 for parsing the incoming video signal. For example, the receiver may include an optical disc unit 58 coupled to the input unit for retrieving the 3D video information from an optical record carrier 54 like a DVD or Blu-ray disc. Alternatively (or additionally), the receiver may include a network interface unit 59 for coupling to a network 45, for example the internet or a broadcast network, such device being a set-top box or a mobile computing device like a mobile phone or tablet computer. The 3D video signal may be retrieved from a remote website or media server, e.g. the 3D source device 40. The 3D image processing device may be a converter that converts an image input signal to an image output signal having the required depth information. Such a converter may be used to convert different input 3D video signals for a specific type of 3D display, for example standard 3D content to a video signal suitable for auto-stereoscopic displays of a particular type or vendor. In practice, the device may be a 3D enabled amplifier or receiver, a 3D optical disc player, or a satellite receiver or set top box, or any type of media player.

The 3D destination device has a depth processor 52 coupled to the input unit 51 for processing the 3D information for generating a 3D display signal 56 to be transferred via an output interface unit 55 to the display device, e.g. a display signal according to the HDMI standard, see “High Definition Multimedia Interface; Specification Version 1.4a of Mar. 4, 2010”, the 3D portion of which being available at http://hdmi.org/manufacturer/specification.aspx for public download.

The 3D destination device may have a stereo-to-depth convertor 53 for generating a destination generated depth map based on the first and second video information. The operation of the stereo-to-depth convertor is equivalent to the stereo-to-depth convertor in the source device described above. A unit having the functions of the destination depth processor 52, the stereo-to-depth convertor 53 and the input unit 51 may be called a 3D decoder.

The destination depth processor 52 is arranged for generating the image data included in the 3D display signal 56 for display on the display device 60. The depth processor is arranged for providing a destination depth map for enabling warping of views for the 3D display. The input unit 51 is arranged for retrieving depth signaling data from the 3D video signal, which depth signaling data is based on source depth information relating to the video information and represents depth processing conditions for adjusting the warping of views. The destination depth processor is arranged for adapting the destination depth map for warping of the views in dependence of on the depth signaling data retrieved from the 3D video signal. The processing of depth signaling data is further elucidated below.

The 3D display device 60 is for displaying the 3D image data. The device has an input interface unit 61 for receiving the 3D display signal 56 including the 3D video data and the destination depth map transferred from the 3D destination device 50. The device has a view processor 62 for generating multiple views of the 3D video data based on the first and second video information in dependence of the destination depth map, and a 3D display 63 for displaying the multiple views of the 3D video data. The transferred 3D video data is processed in the processing unit 62 for warping the views for display on the 3D display 63, for example a multi-view LCD. The display device 60 may be any type of stereoscopic display, also called 3D display.

The video processor 62 in the 3D display device 60 is arranged for processing the 3D video data for generating display control signals for rendering one or more new views. The views are generated from the 3D image data using a 2D view at a known position and the destination depth map. The process of generating a view for a different 3D display eye position, based on using a view at a known position and a depth map is called usually warping of a view. Alternatively the video processor 52 in a 3D player device may be arranged to perform said depth map processing. The multiple views generated for the specified 3D display may be transferred with the 3D image signal via a dedicated interface towards the 3D display.

In a further embodiment the destination device and the display device are combined into a single device. The functions of the depth processor 52 and the processing unit 62, and the remaining functions of output unit 55 and input unit 61, may be performed by a single video processor unit.

It is noted that the depth signaling data principle can be applied at every 3D video transfer step, e.g. between a studio or author and a broadcaster who further encodes the now enhanced depth maps for transmitting to a consumer. Also the depth signaling data system may be executed on consecutive transfers, e.g. a further improved version may be created on an initial version by including second depth signaling data based on a further improved source depth map. This gives great flexibility in terms of achievable quality on the 3D displays, bitrates needed for the transmission of depth information or costs for creating the 3D content.

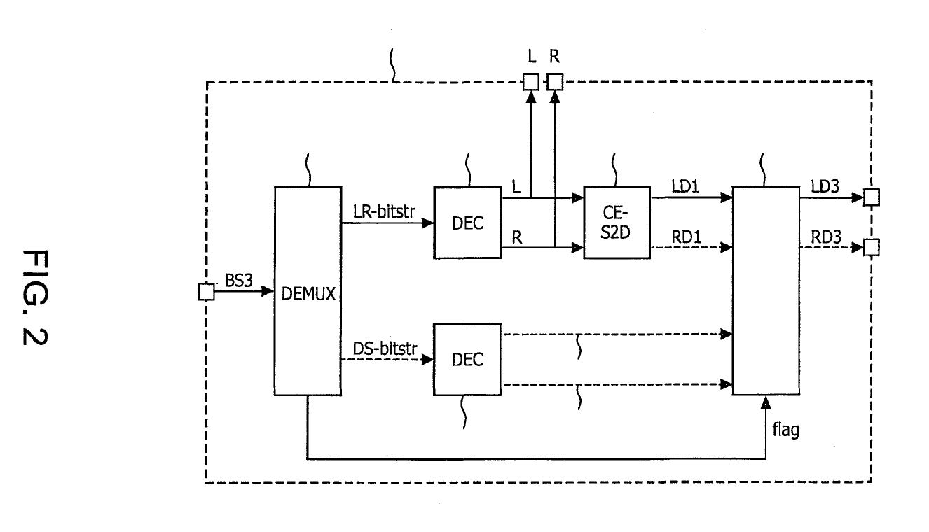

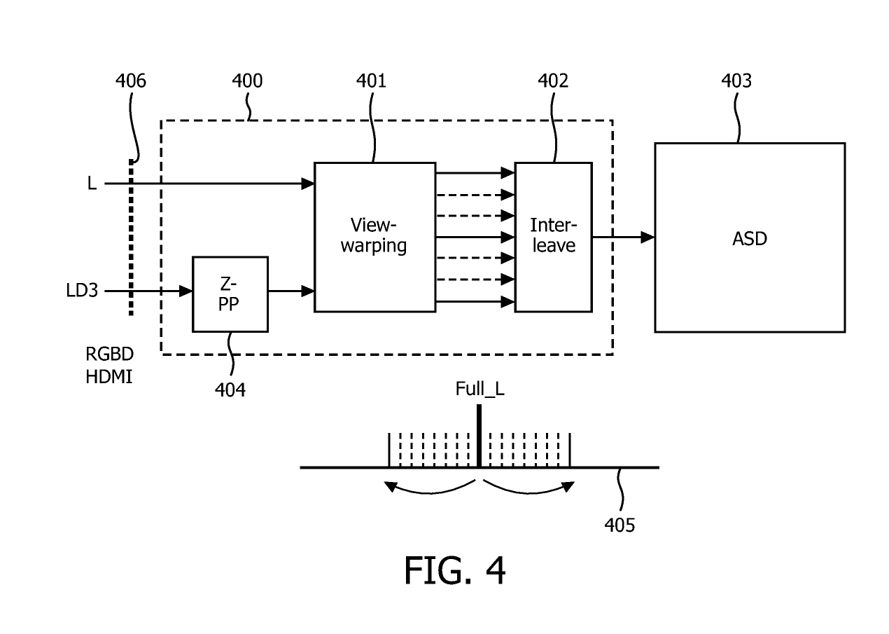

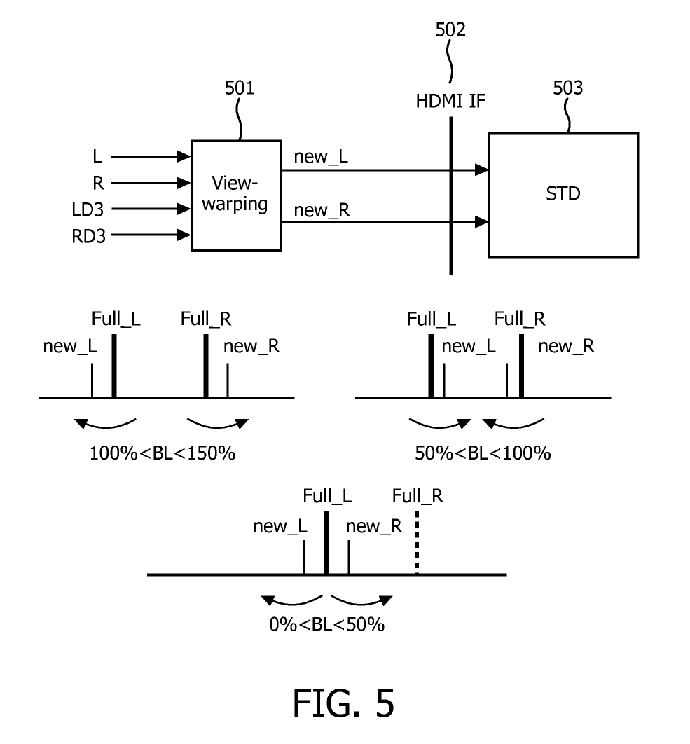

FIG. 2 shows a 3D decoder using depth signaling data. A 3D decoder 20 is schematically shown having an input for a 3D video signal marked BS3 (base signal 3D). An input demuliplexer 21 (DEMUX) parses the incoming data into bitstreams for the left and right view (LR-bitstr) and the depth signaling data (DS-bitstr). A first decoder 22 (DEC) decodes the left and right view to outputs L and R, which are also coupled to a consumer type stereo-to-depth convertor (CE-S2D), which generates an first left depth map LD1 and a first right depth map RD1. Alternatively just a single first depth map is generated, or a depth map is directly available in the incoming signal. A second decoder 23 decodes the DS-bitstr and provides one or more depth control signals 26,27. The depth control signals are coupled to depth map processor 25, which generates the destination depth map, e.g. based on a flag indicating the presence of depth signaling data. In the example a left destination depth map LD3 and a right destination depth map RD3 are provided by using the depth signaling data to modify the initial depth map LD1, RD1. The final destination depth map output of the 3D decoder (LD3/RD3) is then transferred to a view-warping block as discussed with FIG. 4 or 5 depending on the type of display.

The 3D decoder may be part of a set top box (STB) at consumer side, which receives the bitstream according the depth signaling data system (BS3), which is de-multiplexed into 2 streams: one video stream having L and R views, and one depth stream having depth signaling (DS) data which are then both sent to the respective decoders (e.g. MVC/H.264).

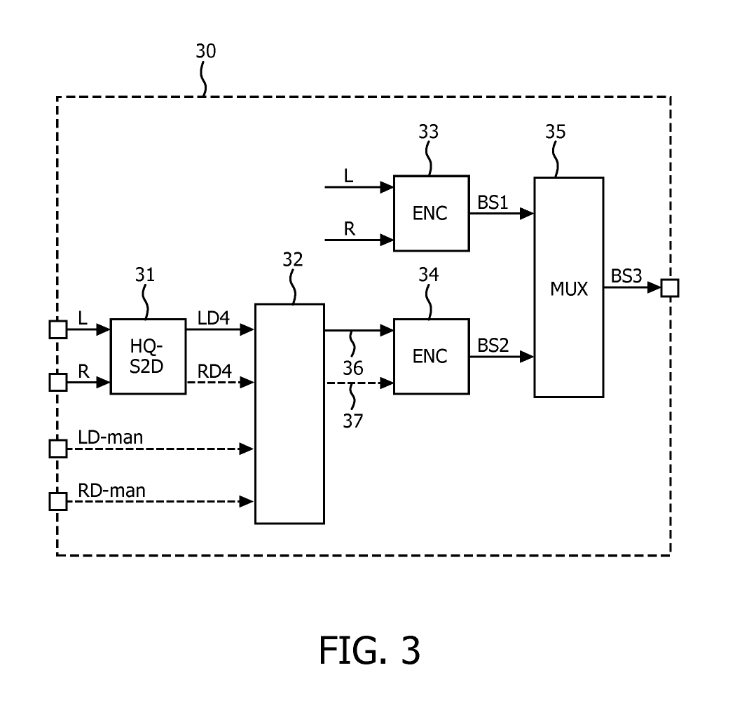

FIG. 3 shows a 3D encoder providing depth signaling data. A 3D encoder 30 is schematically shown having an input (L, R) for receiving a 3D video signal. A stereo-to-depth convertor (e.g. a high-quality professional type HQ-S2D) may be provided to generate a left depth map LD4 and a right depth map RD4, called the source generated depth map. Alternatively a further input may receive the source depth map (marked LD-man, RD-man), which may be provided off-line (e.g. from camera input, manually edited or improved, or computed in case of computer generated content), or may be available with the input 3D video signal. A depth processing unit 32 receives one of, or both, the source generated depth map LD4, RD4 and the source depth map LD-man and RD-man and determines whether depth signaling data is to be generated. In the example two depth signaling data signals 36,37 are coupled to an encoder 34. Various options for depth signaling data are given below.

After encoding the depth signaling data is included in the output signal by output multiplexer 35 (MUX). The multiplexer also receives the encoded video data bitstream (BSI) from a first encoder 33 and the encoded depth signaling data bitstream (BS2) from a second encoder 34, and generates the 3D video signal marked BS3.

Optionally, the source depth processor is arranged for generating the depth signaling data for a period of time in dependence of a shot in the 3D video signal. Effectively the depth signaling data applies to a period of the 3D video signal that has a same 3D configuration, e.g. a specific camera and zoom configuration. Usually the configuration is substantially stable during a shot of a video program. Shot boundaries may be known or can be easily detected at the source side, and a set of depth signaling data is advantageously assembled for the time period corresponding to the shot.

The source depth processor may be arranged for generating the depth signaling data for a period of time in dependence of a shot in the 3D video signal. Automatically detecting boundaries of a shot as such is known. Also the boundaries may already be marked or may be determined during a video editing process at the source. Depth signaling data may be provided for a single shot, and may be changed for a next shot. For example an offset value that is given for a close-up shot of a face, may be succeeded by a next offset value for a next shot of a remote landscape.

The source depth processor may be arranged for generating depth signaling data including region data of a region of interest. The region of interest, when known at the destination side, may be used as a processing condition to be applied to the destination depth map, and warping of the views may be adjusted to enable displaying the region of interest in a preferred depth range of the 3D display. Effectively, the region of interest is constituted by elements or objects in the 3D video material that are assumed to catch the viewer's attention. For example, the region of interest data may indicate an area of the image that has a lot of details which will probably get the attention of the viewer. The destination depth processor can now adapt the depth map so that the depth values in the indicated area are displayed in a high quality range of the 3D display, usually near the display screen, or in a range just behind the screen while avoiding elements protruding in front of the screen. The region of interest may be known or can be detected at the source side, e.g. by an automatic face detector or a studio editor, or depending on movement or detailed structure of objects in the image. A corresponding set of depth signaling data may be automatically generated for indicating the location, the area or the depth range corresponding to the region of interest. The region of interest data enables the warping of views to be adapted to display the region of interest near the optimum depth range of the 3D display.

The source depth processor may be further arranged for updating the region data in dependence of a change of the region of interest exceeding a predetermined threshold, such as a substantial change of the depth position or the location of a face that constitutes the region of interest. Furthermore the source depth processor may be arranged for providing, as the region data, region depth data indicative of a depth range of the region of interest. The region depth data enables the destination device to warp the views while moving object in such depth range to a preferred depth range of the 3D display device. The source depth processor may be further arranged for providing, as the region data, region area data indicative of an area of the region of interest area that is aligned to at least one macroblock in the 3D video signal, the macroblock representing a predetermined block of compressed video data. The macroblocks represent a predetermined block of compressed video data, e.g. in an MPEG encoded video signal. Such region area data will efficiently be encoded and processed. The macroblock aligned region of interest area may include further depth data for locations not being part of the region of interest. Such a region of interest area also contains pixels for which the depth values or image values are not critical for the 3D experience. A selected value, e.g. 0 or 255, may indicate that such pixels are not part of the region of interest.

The 3D video signal may include depth data, e.g. a depth map in addition to the image data. The depth map may include at least one of depth data corresponding to the left view, depth data corresponding to the right view, and/or depth data corresponding to a center view. The 3D video signal may also include a parameter (e.g. num_of_views) indicating the number of views for which depth information is present. Also, the depth data may have a resolution lower than the first video information or the second video information. The source depth processor may be arranged for generating the depth signaling data including a depth data type as a processing condition to be applied to the destination depth map for adjusting the warping of views. The depth data type indicates the properties of the depth data that is included in the 3D video signal, which properties define how the depth data was generated and what post-processing may be suitable for adapting the depth data at the destination side. The depth data type may include one or more of the following property indicators: a focus indicator indicative of depth data generated based on focus data; a perspective indicator indicative of depth data generated based on perspective data; a motion indicator indicative of depth data generated based on motion data; a source indicator indicative of depth data originating from a specific source; an algorithm indicator indicative of depth data processed by a specific algorithm; a dilation indicator indicative of an amount of dilation used at borders of objects in the depth data, e.g. from 0 to 128. The respective indicators enable the depth processor at the destination side to accordingly interpret and process the depth data included in the 3D video signal.

In an embodiment the 3D video signal is formatted to include an encoded video data stream and arranged for conveying decoding information according to a predefined standard, for example the BD standard. The depth signaling data in the 3D video signal is included according to an extension of such standard as decoding information, for example in a user data message or a signaling elementary stream information [SEI] message as these messages are carried in the video elementary stream. Alternatively a separate table or an XML based description may be included in the 3D video signal. As the depth signaling data needs to be used when interpreting the depth map the signaling may be included in additional so called NAL units that form part of the video stream that carries the depth data. Such NAL units are described in the document “Working Draft on MVC extensions” as mentioned in the introductory part. For example a depth_range_update NAL unit may be extended with a table in which the Depth_Signaling data is entered.

FIG. 4 shows an auto-stereo display device and warping multiple views. An auto-stereo display (ASD) 403 receives multiple views generated by a depth processor 400. The depth processor has a view warping unit 401 for generating a set of views 405 from a full left view L and the destination depth map LD3, as shown in the lower part of the Figure. The depth signaling data may be transferred separately, or may be included in the depth map LD3. The display input interface 406 may be according to the HDMI standard, extended to transfer RGB and Depth (RGBD HDMI), and include the full left view L and the destination depth map LD3 based on the depth signaling data HD. The views as generated are transferred via an interleave unit 402 to the display 403. The destination depth map may be processed by a depth post processor Z-PP 404 based on the depth signaling data for adjusting the warping of views, e.g. by applying an offset or gain as described above.

In addition to the signaling for correct interpretation of the depth data there is also provided signaling related to the display. Parameters in the design of the display, such as the number of views, optimal viewing distance, screen size and optimal 3D volume can influence how the content will look on the display. To achieve the best performance the rendering needs to adapt the rendering of the image and depth information to the characteristics of the display. To enable this display designs may be categorized into a number of categories (A, B, C etc.), in the video transmission a table of parameters is included with different parameter values that can be tied to a certain display category. The rendering in the display can then select which parameters values to use based on its own classification. Alternatively the rendering in the display can involve the user whereby the user selects which combination is according to the users taste.

FIG. 5 shows a dual view stereo display device and warping enhanced views. A dual-view stereo display (STD) 503 receives two enhanced views (new_L, new_R) generated by a depth processor 501. The depth processor has a view warping function for generating enhanced views from the original full left view L and the full R view and the destination depth map, as shown in the lower part of the Figure. The display input interface 502 may be according to the HDMI standard, extended to transfer view information IF (HDMI IF). The new views are warped with respect to a parameter BL indicative of the base line (BL) during display. The baseline of 3D video material is originally the effective distance between the L and R camera positions (corrected for optics, zoom factor, etc). When displaying material the baseline will effectively be translated by the display configuration such as size, resolution, viewing distance, or viewer preference settings. In particular, the baseline may be adjusted based on the depth signaling data as transferred to the depth processor 501. To change the baseline during display the positions of the L and R view may be shifted by warping new views, called new_L and new_R, forming a new baseline distance that may be larger (>100%) or smaller (<100%) than the original baseline. The new views are shifted outwards or inwards with respect to the original full L and R views at BL=100%. The third example (0%<BL<50%) has both new views warped based on a single view (Full_L). Warping the new views close to the full views avoids warping artifacts. By the three examples shown the distance between the warped new view and the original view is lower than 25%, while enabling a control range of 0%<BL<150%.

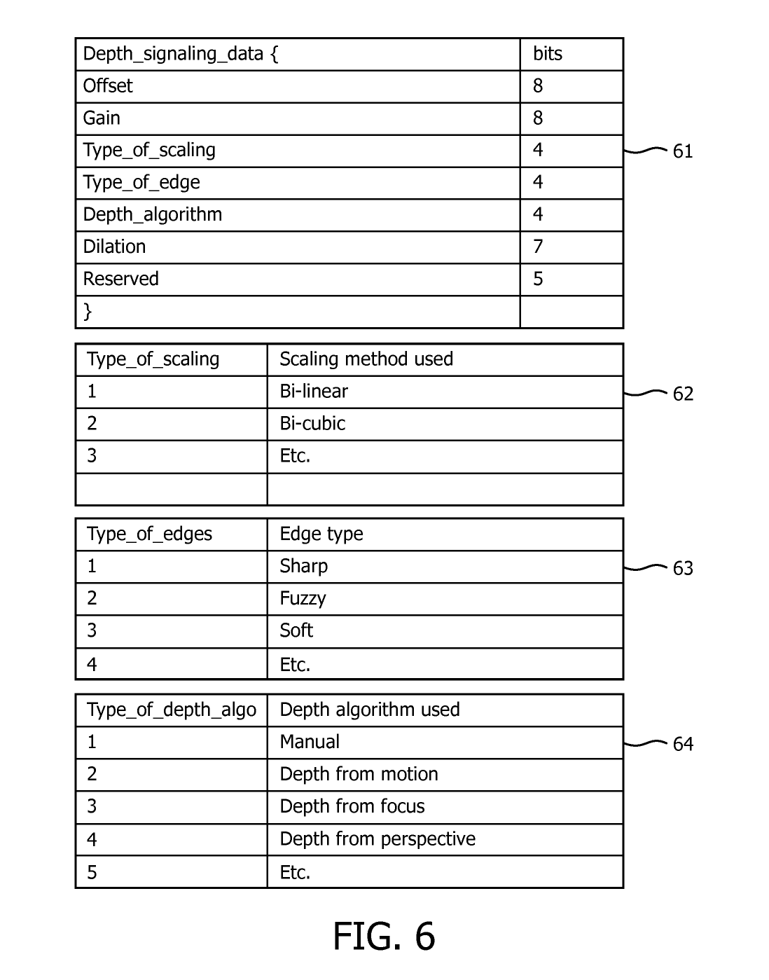

FIG. 6 shows depth signaling data in a 3D video signal. In the Figure a table is shown of depth signaling data transferred in the 3D video signal, e.g. in packets having a packet header indicating the contents of the packet to be depth signaling data. The Figure illustrates including various depth signaling data in the 3D video signal. A first table 61 has the following elements: offset, gain, a type of scaling indicator, a type of edge indictor, a type of depth algorithm indicator and a dilation indicator. A second table 62 has the coding that defines the type of scaling: a first value indicating bi-linear, a second value indicating bicubic, etc. A third table 63 has the coding that defines the type of edges: a first value indicating sharp edges, a second value indicating fuzzy edges, a third value indicating soft edges, etc. A fourth table 64 has the coding that defines the type of depth algorithm used from generating the depth map: a first value indicating manually created depth map, a second value indicating depth from motion, a third value indicating depth from focus, a fourth value indicating depth from perspective. Any combination of the above elements may be used.

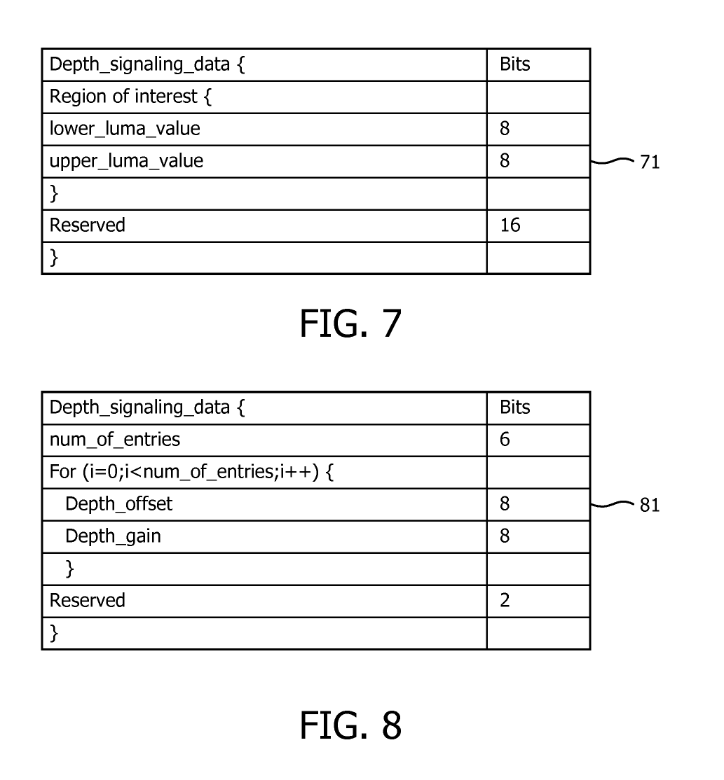

FIG. 7 shows region of interest depth signaling data in a 3D video signal. In the Figure a table 71 is shown of region of interest data transferred in the 3D video signal, e.g. in packets having a packet header indicating the contents of the packet to be depth signaling data of the region of interest. The region of interest is defined by a depth range using two values to be compared to the depth map, lower_luma_value defines the low boundary and upper_luma_value defines the high boundary. So depth values between said boundaries are indicated to contain the region of interest, and therefore the depth map preferably should be processed so that such depth values are displayed in the preferred depth range of the 3D display.

Additionally, the interpretation of the depth data values may be indicated by sign of the difference: the lower lower_luma_value<upper_luma_value may indicate the actual interpretation of the depth information, e.g. in the sense that high luma values determine in a position front of the zero plane (screen depth) of the 3D volume of the 3D display.

The region of interest data differs from the offset and gain values as the frequency in which the latter changes is much lower also the type of data is different. In a preferred embodiment the region of interest as in the table 71 is carried in a NAL unit that carries other depth data, such as the “depth range update”.

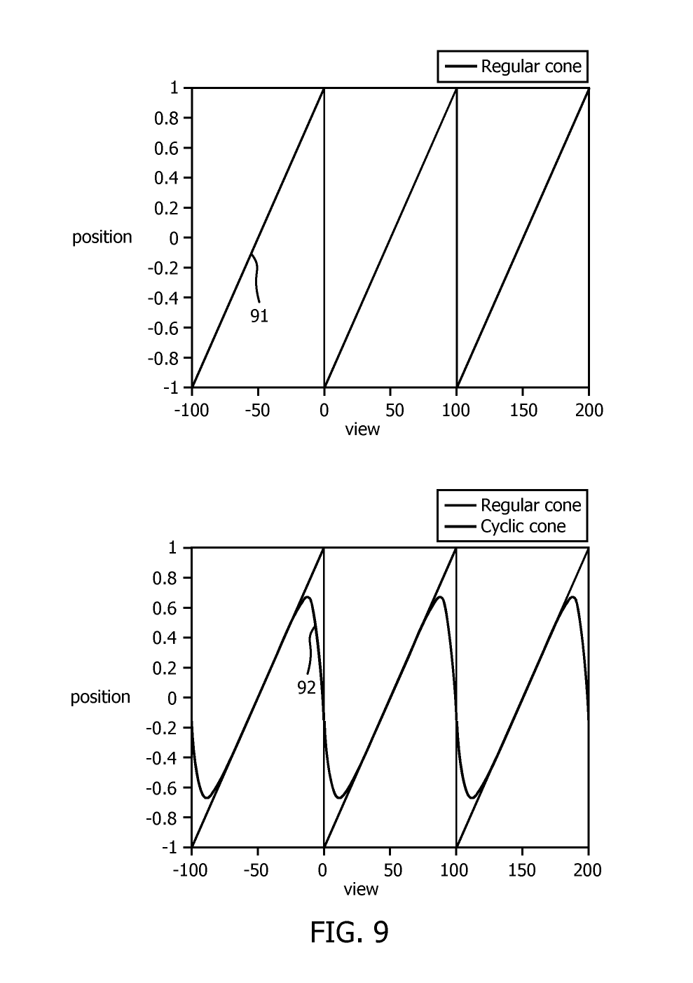

FIG. 8 shows depth signaling data for multiple 3D displays. In the Figure a table 81 is shown of depth signaling data for a multitude of different 3D display types transferred in the 3D video signal, e.g. in packets having a packet header indicating the contents of the packet to be multiple 3D display depth signaling data. First a number of entries is given, each entry being assigned to a specific display type. The display type may also be added in the table as a coded value. Subsequently for each entry a number of depth signaling parameters is given, in the example a depth offset and a depth gain, which are optimized for the respective 3D display type.

In the source device the source depth processor 42 may be arranged for generating the multiple different depth signaling data for respective multiple different 3D display types. The output unit is arranged for including the multiple different depth signaling data in the 3D video signal. In the destination device the destination depth processor is arranged to select, from the table 81 having multiple sets of depth signaling data, the respective set that is suitable for the actual 3D display for which the views are to be warped.

FIG. 9 shows scaling for adapting of the view cone. The view cone refers to the sequence of warped views for a multiview 3D display. The type of scaling indicates the way the view cone is adapted compared to a regular cone in which each consecutive view has a same disparity difference with the preceding view. Altering the cone shape means changing the relative disparity of neighboring views by an amount less than said same disparity difference.

FIG. 9 top-left shows a regular cone shape. The regular cone shape 91 is commonly used in traditional multiview renderers. The shape has an equal amount of stereo for most of the cone and a sharp transition towards the next repetition of the cone. A user positioned in this transition area will perceive a large amount of crosstalk and inverse stereo. In the Figure a saw tooth shaped curve indicates the regular cone shape 91 having a disparity linearly related to its position in the cone. The position of the views within the viewing cone is defined to be zero for the cone center, −1 for entirely left and +1 for entirely right.

It should be understood that altering the cone shape changes only the rendering of content on the display (i.e. view synthesis, interleaving) and does not require physical adjustments to the display. By adapting the viewing cone artifacts may be reduced and a zone of reduced 3D effect may be created for accommodating humans that have no or limited stereo viewing ability, or prefer watching limited 3D or 2D video. The depth signaling data may include the type of scaling which is judged to be suitable for the 3D video material at the source side for altering the cone shape. For example a set of possible scaling cone shapes for adapting the view cone may be predefined and each shape may be given an index, whereas the actual index value is included in the depth signaling data.

In the further three graphs of the Figure the second curve shows the adapted cone shape. The views on the second curve have a reduced disparity difference with the neighboring views. The viewing cone shape is adapted to reduce the visibility of artifacts by reducing the maximum rendering position. At the center position the alternate cone shapes may have the same slope as the regular cone. Further away from the center, the cone shape is altered (in respect to the regular cone) to limit image warping.

FIG. 9 top-right shows a cyclic cone shape. The cyclic cone shape 92 is adapted to avoid the sharp transition by creating a bigger but less strong inverse stereo region.

FIG. 9 bottom-left shows a limited cone. The limited cone shape 93 is an example of a cone shape that limits the maximum rendering position to about 40% of the regular cone. When a user moves through the cone, he/she experiences a cycle of stereo, reduced stereo, inverse stereo and again reduced stereo.

FIG. 9 bottom-right shows a 2D-3D cone. The 2D-3D cone shape 94 also limits the maximum rendering position, but re-uses the outside part of the cone to offer a mono (2D) viewing experience. When a user moves through this cone, he/she experiences a cycle of stereo, inverse stereo, mono and again inverse stereo. This cone shape allows a group of people of which only some members prefer stereo over mono to watch a 3D movie.

In summary, the depth signaling data enables the rendering process to get better results out of the depth data for the actual 3D display, while adjustments are still controlled by the source side. The depth signaling data may consist of image parameters or depth characteristics relevant to adjust the view warping in the 3D display, e.g. the tables shown in FIGS. 6-8. For example, the type of edges in the depth information included in a table indicates a certain type of edge to aid the renderer in getting the maximum results out of the depth data. Also, the algorithm used to generate the depth data may be included to enable the rendering system to interpret this value and from this infer how to render the depth data and warp the views.

It is noted that the current invention may be used for any type of 3D image data, either still picture or moving video. 3D image data is assumed to be available as electronic, digitally encoded, data. The current invention relates to such image data and manipulates the image data in the digital domain.

The invention may be implemented in hardware and/or software, using programmable components. Methods for implementing the invention have steps corresponding to the functions defined for the system as described with reference to FIGS. 1-5.

It will be appreciated that the above description for clarity has described embodiments of the invention with reference to different functional units and processors. However, it will be apparent that any suitable distribution of functionality between different functional units or processors may be used without deviating from the invention. For example, functionality illustrated to be performed by separate units, processors or controllers may be performed by the same processor or controllers. Hence, references to specific functional units are only to be seen as references to suitable means for providing the described functionality rather than indicative of a strict logical or physical structure or organization. The invention can be implemented in any suitable form including hardware, software, firmware or any combination of these.

It is noted, that in this document the word ‘comprising’ does not exclude the presence of other elements or steps than those listed and the word ‘a’ or ‘an’ preceding an element does not exclude the presence of a plurality of such elements, that any reference signs do not limit the scope of the claims, that the invention may be implemented by means of both hardware and software, and that several ‘means’ or ‘units’ may be represented by the same item of hardware or software, and a processor may fulfill the function of one or more units, possibly in cooperation with hardware elements. Further, the invention is not limited to the embodiments, and the invention lies in each and every novel feature or combination of features described above or recited in mutually different dependent claims.

1. 3D source device for providing a three dimensional [3D] video signal for transferring to a 3D destination device,
the 3D video signal comprising
first video information representing a left eye view on a 3D display,
second video information representing a right eye view on the 3D display,
the 3D destination device comprising
receiver for receiving the 3D video signal,
a destination depth processor for providing a destination depth map for enabling warping of views for the 3D display,
the 3D source device comprising
an output unit for generating the 3D video signal, and for transferring the 3D video signal to the 3D destination device,
wherein the 3D source device comprises
a source depth processor for providing depth signaling data, the depth signaling data representing a processing condition for adapting, to the 3D display, the destination depth map or the warping of views,
and the output unit is arranged for including the depth signaling data in the 3D video signal, and the destination depth processor is arranged for
adapting, to the 3D display, the destination depth map or the warping of views in dependence on the depth signaling data.

2. 3D source device as claimed in claim 1, wherein the source depth processor is arranged for providing depth signaling data including at least one of
an offset;
a gain;
a type of scaling;
a type of edges,
as the processing condition.

3. 3D source device as claimed in claim 1, wherein the source depth processor is arranged for providing multiple different depth signaling data for respective multiple different 3D display types, and the output unit is arranged for including the multiple different depth signaling data in the 3D video signal.

4. 3D source device as claimed in claim 1, wherein the source depth processor is arranged for providing the depth signaling data for a period of time in dependence of a shot in the 3D video signal.

5. 3D source device as claimed in claim 1, wherein the source depth processor is arranged for providing depth signaling data including region data of a region of interest as the processing condition to enable displaying the region of interest in a preferred depth range of the 3D display.

6. 3D source device as claimed in claim 5, wherein the source depth processor is arranged for at least one of
updating the region data in dependence of a change of the region of interest exceeding a predetermined threshold;
providing, as the region data, region depth data indicative of a depth range of the region of interest;
providing, as the region data, region area data indicative of an area of the region of interest area that is aligned to at least one macroblock in the 3D video signal, the macroblock representing a predetermined block of compressed video data.

7. 3D source device as claimed in claim 1, wherein the 3D video signal comprises depth data, and the source depth processor is arranged for providing the depth signaling data including a depth data type as the processing condition, where the depth data type includes at least one of
a focus indicator indicative of depth data generated based on focus data;
a perspective indicator indicative of depth data generated based on perspective data;
a motion indicator indicative of depth data generated based on motion data;
a source indicator indicative of depth data originating from a specific source;
an algorithm indicator indicative of depth data processed by a specific algorithm;
a dilation indicator indicative of an amount of dilation used at borders of objects in the depth data.

8. 3D destination device for receiving a three dimensional [3D] video signal from a 3D source device,
the 3D source device comprising
an output unit for generating the 3D video signal, and for transferring the 3D video signal to the 3D destination device,
the 3D video signal comprising
first video information representing a left eye view on a 3D display,
second video information representing a right eye view on the 3D display,
the 3D destination device comprising:
receiver for receiving the 3D video signal,
a destination depth processor for providing a destination depth map for enabling warping of views for the 3D display,
wherein the receiver is arranged for retrieving depth signaling data from the 3D video signal, which depth signaling data represents a processing condition for adapting, to the 3D display, the destination depth map or the warping of views, and
the destination depth processor is arranged for
adapting, to the 3D display, the destination depth map or the warping of views in dependence on the depth signaling data.

9. Destination device as claimed in claim 8, wherein the destination depth processor is arranged for processing the depth signaling data including at least one of an offset;
a gain; a type of scaling; a type of edges, as the processing condition,
or the destination depth processor is arranged for selecting one of multiple different depth signaling data for respective multiple different 3D display types,
or the destination depth processor is arranged for processing the depth signaling data including region data of a region of interest as the processing condition to enable displaying the region of interest in a preferred depth range of the 3D display,
or wherein the 3D video signal comprises depth data and the destination depth processor is arranged for processing the depth signaling data including a depth data type as the processing condition, where the depth data type includes at least one of
a focus indicator indicative of depth data generated based on focus data;
a perspective indicator indicative of depth data generated based on perspective data;
a motion indicator indicative of depth data generated based on motion data;
a source indicator indicative of depth data originating from a specific source;
an algorithm indicator indicative of depth data processed by a specific algorithm;
a dilation indicator indicative of an amount of dilation used at borders of objects in the depth data.

10. Destination device as claimed in claim 8, wherein the receiver comprises a read unit for reading a record carrier for receiving the 3D video signal, or the device comprises
a view processor for generating multiple views of the 3D video data based on the first and second video information in dependence of the destination depth map; and
a 3D display for displaying the multiple views of the 3D video data.

11. Method of providing a three dimensional [3D] video signal for transferring to a 3D destination device,
the 3D video signal comprising
first video information representing a left eye view on a 3D display,
second video information representing a right eye view on the 3D display,
the 3D destination device comprising
receiver for receiving the 3D video signal,
a destination depth processor for providing a destination depth map for enabling warping of views for the 3D display,
the method comprising
generating the 3D video signal,
providing depth signaling data, the depth signaling data representing a processing condition for adapting, to the 3D display, the destination depth map or the warping of views,
and including the depth signaling data in the 3D video signal, and
the destination depth processor being arranged for
adapting, to the 3D display, the destination depth map or the warping of views in dependence on the depth signaling data.

12. Method as claimed in claim 11, wherein the method comprises the step of manufacturing a record carrier, the record carrier being provided with a track of marks representing the 3D video signal.

13. Three dimensional [3D] video signal for transferring 3D video data from 3D a source device to a 3D destination device, the 3D video signal comprising
first video information representing a left eye view on a 3D display,
second video information representing a right eye view on the 3D display,
the 3D destination device comprising
receiver for receiving the 3D video signal,
a destination depth processor for providing a destination depth map for enabling warping of views for the 3D display,
wherein the 3D video signal comprises
depth signaling data, the depth signaling data representing a processing condition for adapting, to the 3D display, the destination depth map or the warping of views,
and the destination depth processor is arranged for
adapting, to the 3D display, the destination depth map or the warping of views in dependence on the depth signaling data.

14. Record carrier comprising the three dimensional [3D] video signal as claimed in claim 13.

15. Computer program product for providing a three dimensional [3D] video signal for transferring to a 3D destination device, which program is operative to cause a processor to perform the respective steps of the method as claimed in claim 11.
